(19) United States
(12) Patent Application Publication
(10) Pub. No.: US 2003/0212569 A1
(43) Pub. Date: Nov. 13, 2003

(54) System for reporting user context information

(76) Inventors: Fabio Casati, Palo Alto, CA (US); Ming-Chien Shan, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/144,282

(22) Filed: May 10, 2002

(51) Int. Cl. G06F 17/60

(52) U.S. Cl. 705/1

(57) ABSTRACT

A system for reporting user context information. The system has context monitors for monitoring user data. The system also has a context change broker communicatively coupled to the context monitors and for receiving the user data. The context change broker also maps the user data to user context information and delivers changes in the user context information to requesting applications.

### TECHNICAL FIELD

The present invention relates to the field of information delivery. Specifically, the present invention relates to a system and method for organizing user context information and providing the information to service providers.

### BACKGROUND ART

Today, organizations use the Web not only as an efficient and cost-effective way to sell products and deliver information, but also as a platform for providing services to businesses and individual users. Services made available electronically to users or applications are typically called e-services, while the term web services refers to the subclass of e-services that are delivered via the web.

E-services represent a shift from a human-driven, “do-it-yourself” Internet to a “do-it-for-me” network of dynamically interacting services. This vision promises to provide many benefits to both customers and service providers, in terms of ease of use, wider service selection, and lower development and maintenance costs. Indeed, due to the high perceived business potential, major software vendors have developed tools and platforms that assist providers in developing, advertising, and delivering e-services, and assist customers in discovering and invoking them.

To provide services that better adapt to the needs of each individual customer, e-service providers exploit Customer Relationship Management (CRM) tools, which offer personalization capabilities, often based on the user's profile (communicated by the users themselves or inferred by past service executions). Due to recent mobile technological advancements people are more connected than ever, and therefore demand e-services in almost any place and at almost any time. Thus, recent work in mobile services enables the delivery of services based on the user's location. Typically, these services receive the user's location as input, use the location as search criteria in a (possibly spatial) database, and return the information to the user. For example, the service provides the user with the location of the Chinese restaurant closest to the present user location.

However, providing services to a mobile user that are pertinent to a user's present situation presents special challenges. For example, while service providers may have access to a user's profile and location, this information is limited in its ability to assist the service provider in providing service to the user. Furthermore, many of these services are unable to anticipate a user's future needs and thus may unable to deliver services in a timely fashion

Additionally, with many web-enabled devices, which are typically characterized by a small display, it is particularly impractical and inconvenient for users to navigate menus and enter substantial amounts of data to specify the exact service needed. Furthermore, it is difficult for service providers to anticipate user's needs and deliver services where and when appropriate, with minimal or no user input.

Thus, one problem with conventional systems is that they fail to provide users with pertinent services in a timely fashion. Another problem with conventional systems is the difficulty users face in getting services delivered. A still further problem is the difficulty service providers face in collecting and processing user data to deliver pertinent services to users.

### DISCLOSURE OF THE INVENTION

The present invention pertains to a system for reporting user context information. The system has context monitors for monitoring user data. The system also has a context change broker communicatively coupled to the context monitors and for receiving the user data. The context change broker also maps the user data to user context information and delivers changes in the user context information to requesting applications.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram illustrating a context change brokering system and associated elements, according to an embodiment of the present invention.

FIGS. 2A-2D are diagrams illustrating mapping of user context information, according to embodiments of the present invention.

FIG. 3 is a diagram of bi-dimensional partitioned mapping structure, according to embodiments of the present invention.

FIG. 4 is a flowchart illustrating steps of a process of providing user context information, according to an embodiment of the present invention.

### BEST MODE FOR CARRYING OUT THE INVENTION

In the following detailed description of the present invention, a method and system device for providing user context information, numerous specific details are set forth in order to provide a thorough understanding of the present invention. However, the present invention may be practiced without these specific details or by using alternate elements or methods. In other instances well known methods, procedures, components, and circuits have not been described in detail as not to unnecessarily obscure aspects of the present invention.

The present invention provides context sensitive information that may be broken into a number of levels of generality. For example, a service provider may be able to provide users specialized services based on a user profile and widely known information such as time and date. In addition, the service provider may be aware of more specialized information, such as the user's location and other information that can help them deliver a better service to their customers. However, just knowing the user's location in terms of, for example, an (x,y,z) geographical coordinate may not provide the right level of generality to be useful. For example, if the user's location is provided by a GPS system, the service provider knows the user's geographic position, with perhaps great accuracy. However, what is more valuable to a service provider is whether the user is in a rural or urban setting or whether it is raining at the user's location.

Embodiments of the present invention deliver a new class of electronic-services, tailored not only to a specific user profile, but also to a user context at the time the service is requested. For instance, a skier visiting a mountain resort in the winter season could receive information about the cost of ski passes and nearby boot rental locations, or spectators at a football game may be shown the location of their seats and order food to be delivered to them at half-time.

Embodiments of the present invention extend the notion of location-dependent (sometimes called location-based) services, by progressively adding semantics to the concept of location. In fact, location-based services customize their offering based on the geographical (latitude, longitude, and altitude) or geo-political (e.g., city, state, and country) position. However, many services require higher-level information about the user location in order to be effective. For instance, services may be interested in knowing in which meeting room the users are located, what weather conditions the users' are experiencing, in which occupation the users are engaged, and so on.

The services may be for mobile users as well as static users. As such, context changes apply to static users as well. Examples of context changes for static users may include time of the day, present occupation, weather, or stock portfolio. Thus, the present invention is not limited to the services being location-dependent services. For example, a service based on stock portfolio does not depend on the user's location. However, some context changes for static users, such as the weather, may depend on location.

Thus, an embodiment of the present invention is an architecture that supports the detection and delivery of aggregate, high-level context information to authorized services. The term “context”, as used in this description, is a very generic concept that includes a wide range of semantic attributes. In addition, part of the context information may be a prediction of future context (e.g., a prediction that the user will be in a given place or situation at a given time).

The context information is provided to consumers (e.g., service providers) at a level of abstraction of their choice. Thus, the service providers are able to easily provide their services to consumers. For example, a portfolio management service may be interested in the details of the stock a user owns, as well as every buy and sell transaction. On the other hand, a tax calculator service may only be interested in aggregate, higher-level information, such as the total gain or loss deriving from short and long term transactions. As another example, a driving direction service may be interested in the exact (x,y) location coordinates of a vehicle, while a restaurant reservation service may only be interested information about the city in which the user is located.

Thus, embodiments of the present invention alleviate the need for service developers to design and implement the logic for capturing context change events and for processing them. Embodiments factorize semantic context mapping within a specialized component. Therefore, the mapping work needs to be done only once for all service providers interested in the context change. In addition, the mapping logic may be stored in one place, so that it may be easily maintained. Service providers greatly benefit from having context and context change information readily available, so that they can deliver services that are tailored to specific users in the specific context in which they reside.

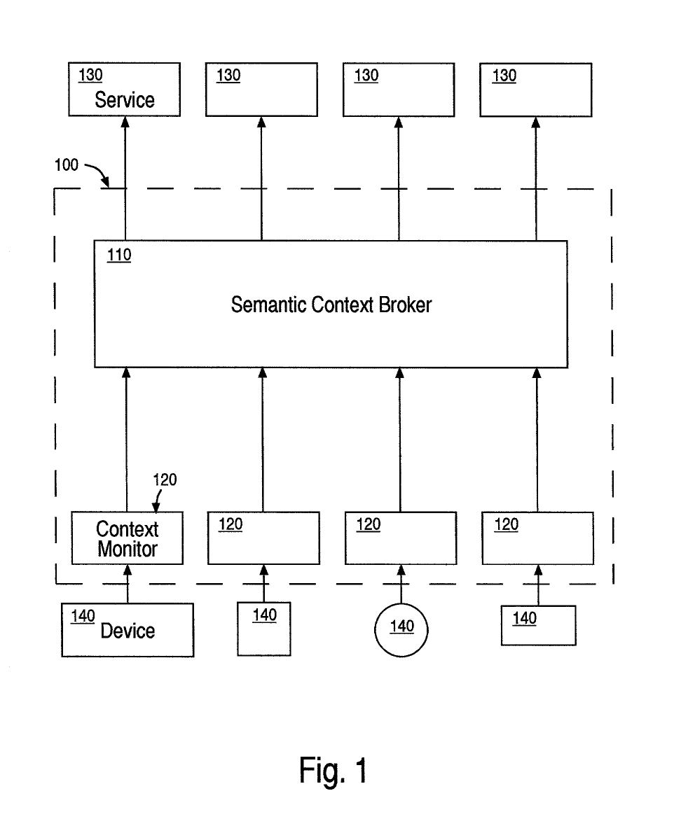

FIG. 1 illustrates a context broker architecture 100 and elements with which it interacts, according to an embodiment of the present invention. The semantic context broker 110 extends “traditional” e-services architectures by providing support for context-services. The semantic context broker 110 may reside on a server, although this is not required. In particular, the semantic context broker 110 can capture context-change events, typically notified at low abstraction levels (e.g., change in (x,y,z) geographical coordinates, which may be notified by a GPS (Global Positioning System)), filter and map them at different levels of abstractions (e.g., determine whether there has been a change in the city or state), and deliver them to interested services 130 (or service providers). The services 130 use the context change information to deliver services in a timely fashion, for example, to proactively deliver information to users. The semantic context broker 110 may also aggregate and dispatch context change events, and make context predictions. For example, if the user is in a supermarket or department store, semantic context broker 110 may predict what aisle or region the user will enter next. The prediction may be provided to a service 130, which may use the prediction when relaying services to the user.

The architecture 100 may also have a number of context monitors 120, which monitor user information. The context monitors 120 may reside within devices 140 such as, a personal digital assistant, an automobile driving system, a thermostat of a house, etc. However, the context monitors 120 may also reside outside a device 140 that is being monitored for user data. The context monitors 120 may report the low-level data collected from these devices 140 to the semantic context broker 110. The context monitors 120 may also map the low-level information to higher-level context information at different levels of generality and report this to he semantic context broker 110, although this is not required. The low-level information may be information such as, for example, geographic position, temperature, etc. If the context monitor 120 is performing the mapping, it may map, for example, a longitude and latitude coordinate to a room or building in which the user is located.

The context monitors 120 may be configured to specify which events should be monitored (e.g., what user information to collect) and whom (e.g., which services 130) should be notified of such events. The configuration may be done through the device 140, may be predefined, or may be downloaded from the semantic context broker 110. Thus, context monitors 120 detect changes that the user is willing to report to a given (set of) service provider(s) 130, filter these events (if the burden of transmitting all events is excessive or the level of detail irrelevant), generate higher-level, semantic information from the measured context change, translate this information into a common format, and finally notify the change to the semantic context broker 110.

The architecture 100 may follow the principles of message brokering technology; however, the present invention is not limited to message broker technology. Message brokers may be appropriate for detecting and delivering context change information. In fact, one of their main functions is to monitor data sets and notify changes to interested applications in a uniform way (e.g., with a uniform language and protocol). Consequently, they are well suited to implement aspects of the present invention.

Embodiments provide sophisticated event processing and analysis, in order to extract high-level, semantic information. For instance, to detect room changes of users walking in their houses, the user's spatial coordinates may be mapped into semantic information about the room in the house in which the user is located.

Embodiments of the present invention proactively deliver context information. This allows context-sensitive and context-dependent applications to be able to deliver their services in correspondence of (actual or foreseen) context changes.

A context may be a set of information about an entity (typically, a human user). It may include static (or slowly changing) information such as user preferences (profile), but it may also include dynamic information, such as details about the environment in which the entity is or has been.

The notion of context-dependent service extends that of location-dependent (sometimes called location-based) services, by adding more semantics to the concept of location. Location-based services customize their offering based on the geographical (latitude, longitude, and height) or geo-political (e.g., city, state, and country) position. However, many services require higher-level information about the user location in order to be effective. For instance, teleconferencing services may be interested in knowing in which meeting room the user is located. Table 1 provides several examples of semantically-extended notions, based on location. Each row shows different attributes that may be defined for a given location. The attributes may be mutually exclusive, although that is not always the case.

TABLE 1

| | | |
|---|---|---|
| seaside | mountain | |
| at work | at home | |
| cubicle | meeting room | cafeteria |
| boat | car | train |
| living room | kitchen | bathroom |
| warm location | cold location | |
| rain | storm | sunshine |
| humid | dry | |
| French | English | German |
| skiing | swimming | sightseeing |

However, attributes are not necessarily based on the user's location. Besides location, the notion of context may include other kinds of (typically dynamic) information about the user. For example, it may include the current occupation of the user (e.g., in a meeting, on the telephone, resting, on holiday, watering the plants). In general, the context may include all kinds of information, ranging from bank account balances to health conditions. In general, the context may include a possibly unlimited number of attributes.

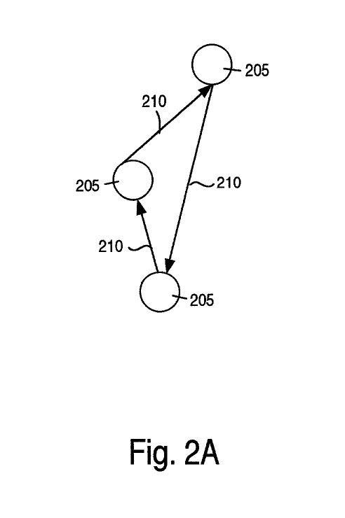

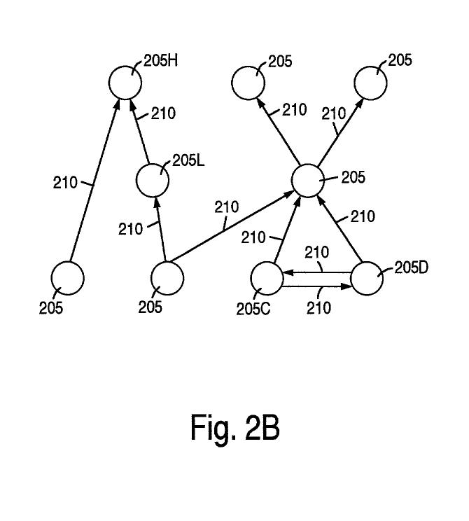

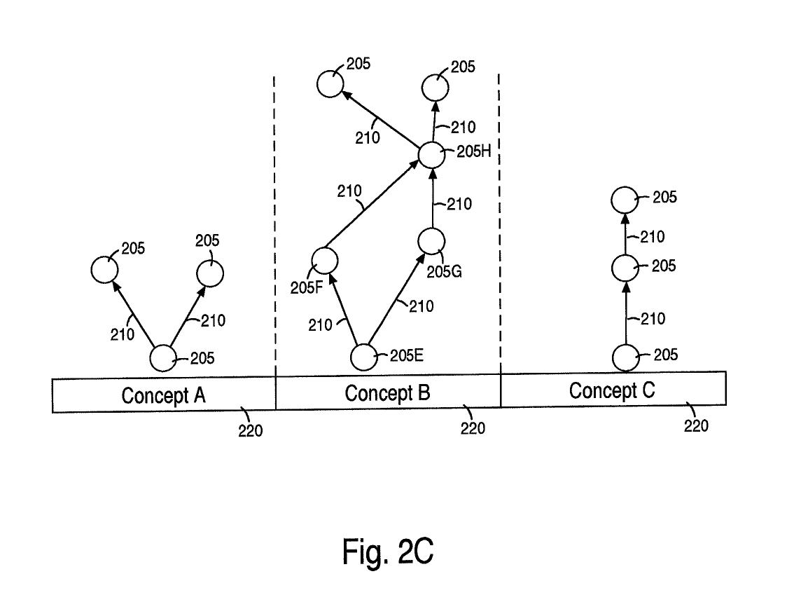

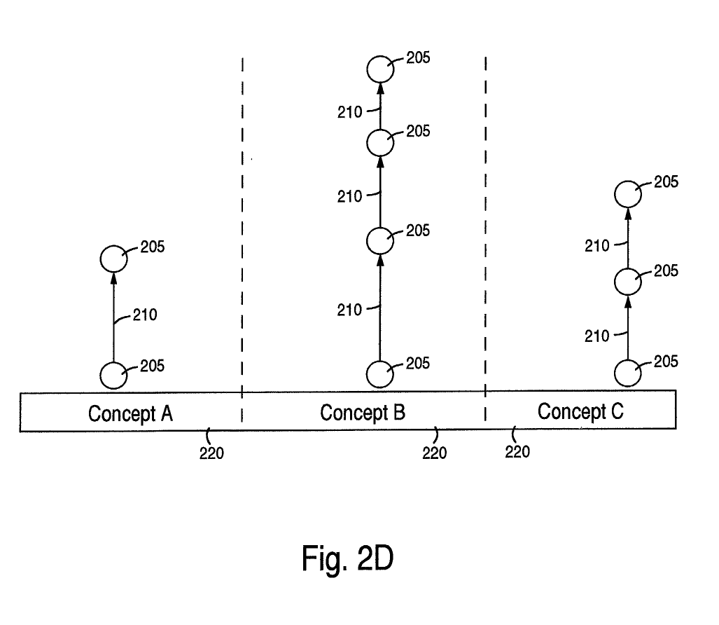

At some point, the low-level user data is mapped to higher-level context information (e.g., mapped to one or more attributes). This mapping may be performed by the context monitors 120 or by the semantic context broker 110. FIG. 2A illustrates one such way to perform the mapping. The mapping produces high-level abstractions from the low-level data that the context monitors 120 collect.

Referring now to FIG. 2A, in this embodiment, a context schema is composed of a set of independent attributes 205 that are linked by mapping functions 210. An attribute 205 may be qualified by a name and a data type (e.g., temperature, integer). It can also be complex, e.g., characterized by a set of <name, type> pairs. Each user, at any given time, is associated to a context instance, e.g., a specific set of values for attributes 205 defined in the context schema. Attributes 205 may be added to or removed from 205 this set. In addition, business logic (e.g., mapping 210) may be defined to propagate changes to an attribute 205 into changes to other attributes 205. In this embodiment, any attribute 205 may map to any other attribute 205.

FIG. 2B illustrates an embodiment in which attributes 205 and mappings 210 form a lattice. In this embodiment, a context schema is represented by a set of attributes 205 that are partially ordered based on their level of abstraction. An attribute 205H may be defined to be at a higher level of abstraction with respect to attribute 205L (H>L) if: 1) there exists a mapping function 210 m(L)→H (or a transitive closure of such mapping functions 210), e.g., a function that allows to determine the new value of H based on changes in the value of L; and 2) there is no mapping function 210 (or a transitive closure of mapping functions 210) m(H)→L that derives the new value of L based on changes of values of H.

Two attributes (e.g., L₁, L₂) are at the same level if there are two functions m₁ and m₂ such that m₁(L₁)→L₂ and m₂(L₂)→L₁. For example, in FIG. 2B attribute 205C is at the same level as attribute 205D.

When two attributes 205 are at the same level, the context model may consider them as being different viewpoints of the same attribute 205. For example, temperature can be expressed in centigrade or Fahrenheit degrees. There may be conversion functions that allow transforming centigrade into Fahrenheit and vice versa. Therefore, centigrade and Fahrenheit measures may be referred to being two different viewpoints of the same attribute 205.

The lattice structure may have many variations. For example, it is possible to impose a more structured lattice where attributes 205 are organized into abstraction levels 1, 2, . . . j , . . . , n such that for each attribute Lⱼ at level j there exists an attribute Lⱼ₋₁ at level j−1 such that m(Lⱼ₋₁)→lⱼ, and there exist no attribute A at any level other than j−1 such that m(A)→lⱼ.

Referring now to FIG. 2C, the lattice-based model can be further structured by imposing that attributes 205 are qualified by a concept 220 (such as, for example, geographical location, occupation, geopolitical location, temperature, etc.). In this model, mapping functions 210 do not cross concept boundaries. For example, a function m(A)→B can be defined if and only if attribute A and attribute B belong to the same concept. Concepts 220 and attributes 205 may be defined by in any suitable fashion.

The root of a graph, for example, attribute 205E, may be an (x,y,z) geographical coordinate, such as longitude, latitude, and altitude. From there, the user information is mapped up to two different attributes 205F and 205G. In this case, those two attributes 205 may be zip code and neighborhood. Attributes 205F and 205G may map to attribute 205H, which may be the city. The system may have any number of such graphs, thus covering many different conceptual situations.

The concept 220 notion makes it easy for service providers 130 to visualize the definitions of attributes 205 and mappings 210, and to understand to what event they need to subscribe to get the information they need. This is very useful when the system is complex and has thousands of attributes 205.

FIG. 2D illustrates an embodiment in which for each concept 220, there is a linear hierarchy of mappings 210. For example, each attribute 205 is the source of at most one mapping 210 and the destination of at most one mapping 210.

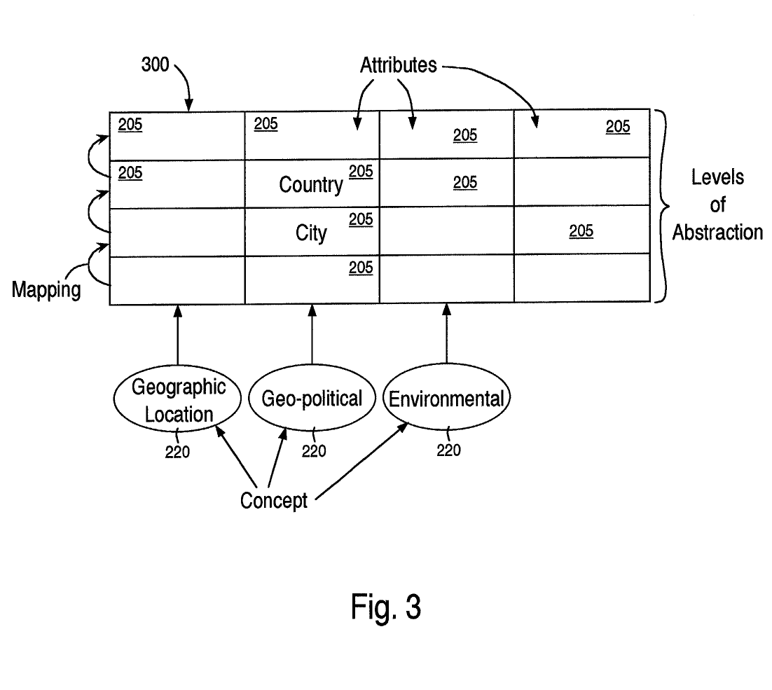

FIG. 3 illustrates another way of expressing the case in which there is a linear hierarchy of mappings 210 for each concept 220. In this case, a matrix structure 300 is used with each column being a separate concept 220, each row a different abstraction level for the concept 220 in that column, and attributes 205 in each box.

The semantic context broker 110 has knowledge about the matrix structure 300 of the mappings 210, and the matrix structure 300 is very simple. It is very easy at run time to determine which mapping function 210 should be executed, and in particular, there is only one mapping function 210 for each state, so performance is efficient. In addition, the matrix structure 300 makes it easy for services 130 to manage the definitions and to identify the events to which they want to subscribe.

The matrix structure 300 also makes it possible for services 130 to specify that they wish to receive events about a specific concept 220 at the highest or lowest available abstraction level (e.g., they can specify that they are interested in changes in the user's zip code, but if this information is not available and only the information about the user's city—which is at a higher abstraction level—will suffice). One concept 220 relates to geographic location, another relates to geopolitical factors, still another to environmental. The bottom row of the table may contain low-level information, which may be the actual data that is collected. For example, it may be a user's longitude and latitude. However, the bottom row will not always be the low level data that is collected. For example, if the concept is environmental conditions, the location data may be used to determine environmental conditions. However, it may also be that environmental conditions are taken directly from collected data, for example, a household thermostat. The next row up in that column is an attribute 205 that may be derived from the one below it. For example, city may be derived from zip code. In this fashion, the attributes 205 become more general higher up the matrix structure 300. A service 130 may request context information (e.g., an attribute 205) at any level of generalization. Whenever, the information at a level changes, the semantic context broker 110 delivers to the service 130 the new context information. The columns need not have the same number of rows. For example, the concepts 220 may have different numbers of abstraction levels.

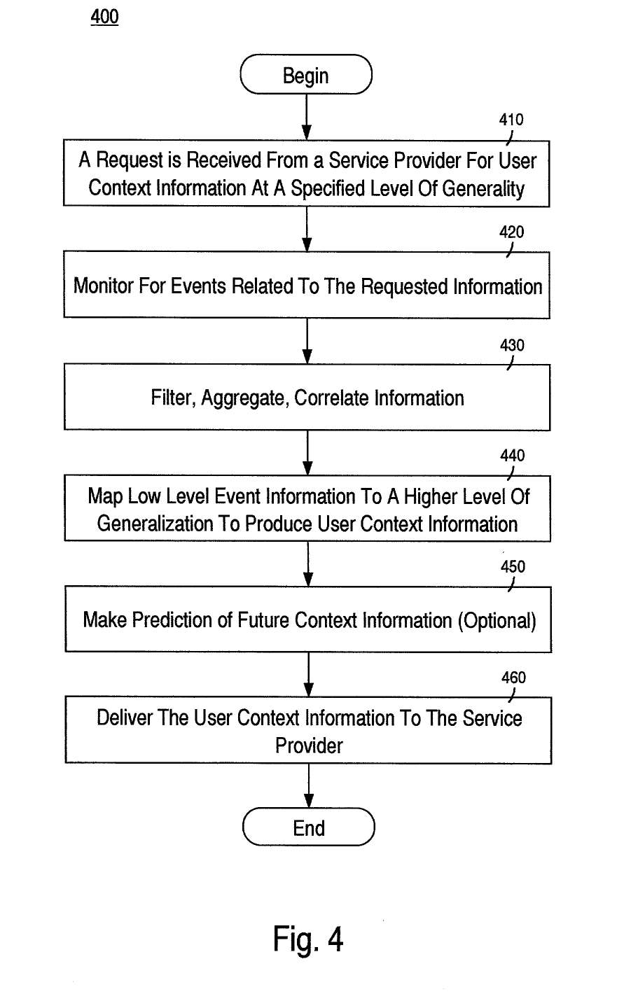

FIG. 4 describes a process 400 illustrating a general flow of providing context based services to a user. Embodiments of the present invention perform a subset of these steps. Some of the steps of process 400 may be stored as instructions on a computer readable medium and executed on a processor of a computer system. In step 410, a request (e.g., subscription) is received from a service 130 for user context information at a specified level of generality. For example, a service 130 desires context information about the neighborhood in which the user is in order to provide information about nearby restaurants.

In step 420, one or more context monitors 120 monitor for events related to the requested information. The context monitors 120 may already be programmed to monitor for this information. For example, numerous services 130 may be interested in information that requires the same user data be collected. However, this does not mean they are necessarily interested in the same attributes 205. For example, one could be interested in the neighborhood and the other in the weather at the user's location.

In step 430, the user information is filtered, aggregated, and correlated. In this fashion, the large volume of data that is potentially collected is cut down to a more manageable size. However, this step is not always taken. Thus, performance and event load are considered. At a fine granularity, the “context” of a user may change frequently, which means that each user would be possibly generating events every second or even less. Consequently, the context monitors 120 may perform filtering and aggregation.

In step 440, low-level event information is mapped to a higher level of generalization. This may be done by any of the schemas and methods in FIGS. 2A-2D or FIG. 3, or other suitable mapping methods. A mapping function 210 may be implemented in a programming language, such as, for example, Java or SQL (Structured Query Language). Alternatively, a mapping function 210 may be computed by invoking a service whose purpose is to compute mapping functions. The information that was collected may be used in multiple mappings. For example, both current location and weather conditions may be based on an (x,y) coordinate.

In step 450, a prediction of future context information is performed. This step is optional. An example of this step is to predict which aisle of a store a user will be in next. Predictions may be made using existing prediction techniques, such as, for example, those based on data mining.

In step 460, the user context information is delivered to the service 130. The service 130 may then use the information to deliver to the user timely services based on a context related to the user. Process 400 may then end.

While the present invention has been described in particular embodiments, it should be appreciated that the present invention should not be construed as limited by such embodiments, but rather construed according to the below claims.

What is claimed is:

1. A system for reporting user context information, comprising:
a plurality of context monitors for monitoring user data;
a context change broker communicatively coupled to said plurality of context monitors and for receiving said user data and mapping said user data to user context information; and
said context change broker further for delivering changes in said user context information to requesting applications.

2. The system of claim 1, wherein said context change broker is further for making predictions of future user context information.

3. The system of claim 1, wherein said context change broker is further for aggregating said user data.

4. The system of claim 1, wherein said context monitors are further for filtering said user data.

5. The system of claim 1, wherein said context monitors are further for correlating said user data.

6. The system of claim 1, wherein said context monitors are further for aggregating said user data.

7. The system of claim 1, wherein a context monitor of said plurality is further for mapping said user data to said user context information.

8. A method of providing user information, comprising:
a) receiving a request for user context information at a specified level of generality;
b) monitoring for low level user data related to said user context information;
c) mapping said low level user data to said user context information at said specified level of generality; and
d) delivering said user context information at said specified level of generality to a requestor.

9. The method of claim 8, further comprising:
e) repeating said a) through said d) for a plurality of concepts for said user.

10. The method of claim 8, further comprising:
e) mapping said low level user data from said b) to user context information at a different level of generality than in said c).

11. The method of claim 8, further comprising:
e) determining that said user context information at said specified level of generality has changed since last delivered; and
f) delivering said changed user context information.

12. The method of claim 8, further comprising:
e) predicting user future context information.

13. A computer readable medium having stored thereon instructions which, when executed on a processor, implement a method of mapping user data, said method comprising:
a) monitoring for user data;
b) converting said user data to a semantic form having a plurality of context attributes at one or more levels by applying said user data to a context schema comprising said context attributes linked by mapping functions; and
c) delivering a context attribute of said plurality.

14. The computer readable medium of claim 13, wherein said method further comprises receiving an instruction to monitor for said user data.

15. The computer readable medium of claim 13, wherein said context attributes and said mapping functions form a lattice.

16. The computer readable medium of claim 15, wherein two of said context attributes are at the same level of said context schema.

17. The computer readable medium of claim 14, wherein said context schema is divided into a plurality of concepts comprising groups of said plurality of context attributes linked by mapping functions.

18. The computer readable medium of claim 17, wherein a concept comprises a linear hierarchy of said mapping functions.

19. The computer readable medium of claim 13, wherein said method is implemented on top of a message broker.
